(19) United States
(12) Patent Application Publication
(10) Pub. No.: US 2019/0106012 A1
(43) Pub. Date: Apr. 11, 2019

(54) Networked Gate Machines Gaging the Condition of Unmanned Platforms

(71) Applicant: Thomas Freund, West Hartford, CT (US)

(72) Inventor: Thomas Freund, West Hartford, CT (US)

(21) Appl. No.: 16/216,663

(22) Filed: Dec. 11, 2018

Related U.S. Application Data
(63) Continuation-in-part of application No. 15/448,025, filed on Mar. 2, 2017.
(60) Provisional application No. 62/302,414, filed on Mar. 2, 2016.

(51) Int. Cl. G05B 19/042

(52) U.S. Cl. CPC B60L 11/1844; B60L 11/1861; G05B 2219/2639; B60L 11/1824; B60L 11/1816; G05B 19/042

(57) ABSTRACT

A system for gaging the condition of unmanned platforms is provided. The system can include a plurality of gate machines having a processor and a memory. The system further includes a plurality of sensors for receiving operational data for the unmanned platforms and sending the operational data to the plurality of gate machines. The plurality of gate machines can include computer-readable instructions stored thereon which, when executed by the plurality of gate machines, cause the plurality of gate machines to perform various steps. One of the steps can include converting the raw signals from the plurality of sensors to normalized values. Another step can include executing a set of obligations if a gate trigger is valid. Finally, another step can include testing one or more subsequent gates of the plurality of gate machines if the gate closure condition is valid.

### RELATED APPLICATIONS

This application is a continuation-in-part of U.S. patent application Ser. No. 15/448,025 filed on Mar. 2, 2017, which claims priority to U.S. Provisional Patent Application No. 62/302,414 filed on Mar. 2, 2016, the entire disclosures of which are hereby expressly incorporated by reference.

### BACKGROUND

### Field of the Disclosure

The present disclosure relates generally to networked gate machines gaging the condition of unmanned platforms, such as drones, unmanned aerial vehicles, etc.

### Related Art

Commercial unmanned platforms are growing both in diversity, projected applications, and endurance requirements. One example is physical infrastructure (e.g. power generation and transmission) inspection. As availability needs grow for power, the demand for continuous inspection increases. This, in turn, puts increased reliability demands on unmanned inspection platforms tasked with looking after transmission lines, for example, in hard-to-access spots.

Similar things can be said about other uses of unmanned platforms such as freight transportation and agriculture. As demands for a continuous “belt” of faster freight movement increase, the reliability demands on unmanned freight transportation platform increase at an ever faster pace. In addition, the long-range, beyond-line-of-sight nature of many of these uses necessitates a self-contained means to monitor and safely control platform operation.

Current platform equipment oversight, however, has not progressed and is not projected to catch up sufficiently to these demands. Accordingly, there is a need for an embedded oversight mechanism that looks after the condition of unmanned platform systems and precludes them from ever reaching potential failure. In particular, there is a need for a mechanism that “shadows” system operation. This “shadowing” mechanism must be based on the deepest knowledge of the structure and operation of that system possible. Yet, it should enable rapid reaction to any anomaly detected that can foreshadow potential faults. It should also be capable of operating within a resource constrained computational environment (e.g. microcontrollers). The system of the present disclosure solves these, and other, needs.

Moreover, unmanaged electric vehicle (“EV”) charging can impact electric availability to regions with constrained power distribution hubs, which exist in a number of places worldwide. Replacement of a distribution hub is very expensive and logistically challenging. Accordingly, there is a need for a more cost effective approach for an intelligent charging system.

### SUMMARY

The present disclosure relates to networked gate machines gaging the condition of unmanned platforms. In particular, a system for gaging the condition of unmanned platforms includes a plurality of gate machines each having a processor and a memory. The system further includes a plurality of sensors for receiving operational data for the unmanned platforms and sending the operational data to the plurality of gate machines. The plurality of gate machines can include computer-readable instructions stored thereon which, when executed by the plurality of gate machines, cause the plurality of gate machines to perform various steps. One of the steps can include converting the raw signals from the plurality of sensors to normalized values. Another step can include executing a set of obligations if a gate trigger is valid. Finally, another step can include testing one or more subsequent gates of the plurality of gate machines if the gate closure condition is valid.

A method for gaging the condition of unmanned platforms is also provided. The method can provide a plurality of gate machines each having a processor and a memory. The method can further provide a plurality of sensors for receiving operational data for the unmanned platforms and sending the operational data to the plurality of gate machines. The method can also convert the raw signals from the plurality of sensors to normalized values. The method can additionally execute a set of obligations if a gate trigger is valid. Finally, the method can test one or more subsequent gates of the plurality of gate machines if the gate closure condition is valid.

A system for charging a plurality of electric vehicles is provided. The system includes a plurality of electrical charging stations each having a charge station for providing electrical charging capacity to the plurality of electric vehicles, and a memory and processor for receiving and transmitting information. The system also includes a computing device having a memory and processor on a location at a utility supplying power and a computing device having a memory and processor at each electric vehicle charging location. First, the system receives a plurality of charge levels for each of the plurality of electric vehicles, the plurality of charge levels each indicating an amount of charge remaining in a battery installed in each of the plurality of electric vehicles. Second, the system calculates an allocation level for each of the plurality of electric vehicles based on each electric vehicle's charge level, a total amount of charging capacity available for the plurality of charging stations, and a sum of all the plurality of charge levels for the plurality of electric vehicles. Third, receiving a request from at least one of the plurality of electrical charging stations for charging at least one of the plurality of electric vehicles to a requested charge level. Fourth, transmitting, to the at least one of the plurality of electrical charging stations, the at least one of the plurality of electric vehicle's calculated allocation level.

A method for managing a plurality of charging stations for charging a plurality of electric vehicles is also provided. The method includes receiving a plurality of charge levels for each of the plurality of electric vehicles, the plurality of charge levels each indicating an amount of charge remaining in a battery installed in each of the plurality of electric vehicles. The method also includes calculating an allocation level for each of the plurality of electric vehicles based on each electric vehicle's charge level, a total amount of charging capacity available for the plurality of charging stations, and a sum of all the plurality of charge levels for the plurality of electric vehicles. The method also includes receiving a request from at least one of the plurality of charging stations for charging at least one of the plurality of electric vehicles to a requested charge level. The method further includes transmitting, to the at least one of the plurality of charging stations, the at least one of the plurality of electric vehicle's calculated allocation level.

### BRIEF DESCRIPTION OF THE DRAWINGS

The foregoing features of the disclosure will be apparent from the following Detailed Description, taken in connection with the accompanying drawings, in which:

FIG. 1 is a diagram of an individual gate operation;

FIG. 2 is a diagram of an inter-gate-machine mailbox server operation;

FIG. 3 is a diagram of a mission gate machine interaction with the mailbox server;

FIG. 4 is a diagram of a task list operation;

FIG. 5 is a diagram of a task interpreter configuration;

FIG. 6 is a diagram of a charging system in accordance with the present disclosure;

FIG. 7 is a flowchart illustrating processing steps for configuring a network gate machine;

FIG. 8 is a flowchart illustrating processing steps for charging an electric vehicle; and

FIG. 9 is a flowchart illustrating processing steps for implementing an inter-gate machine.

### DETAILED DESCRIPTION

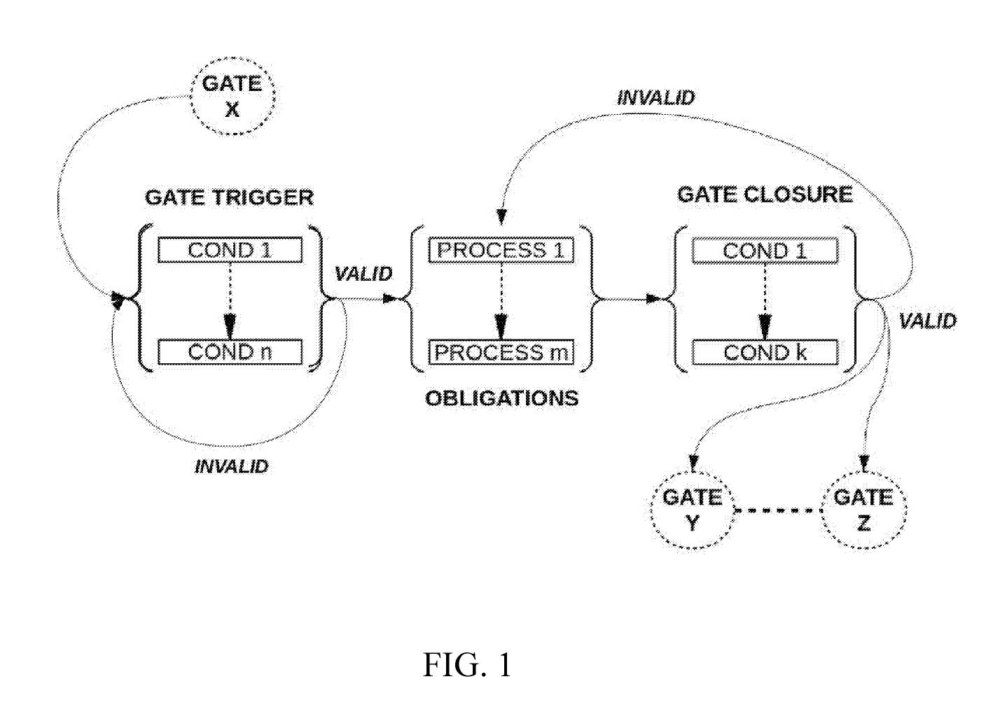

Disclosed herein are networked gate machines gaging the condition of unmanned platforms, as discussed in detail below in connection with FIGS. 1-9.

The “shadowing” mechanism of the present disclosure is a network of gate machines. Each gate machine resides in an individual hardware configuration (e.g., having a processor and memory) and being attached to the system being “shadowed”. Each gate machine has software embedded in these hardware elements and is implemented as a network of linked pairs of conditional expressions, termed gates, coupled with a list of resources, or parameters associated with the operation of the system being “shadowed”.

The contents of a resource are values associated with individual operations constituting a single cycle of operation for the system being “shadowed”. These values are obtained via physical sensors attached to the “shadowed” system. The sensors can receive operational data for the unmanned platforms and can send the operational data to the gate machine.

More specifically, as used herein, a “resource” is an information structure consisting of the following components:
1. label—an internal identifier of the resource,
2. range—either the maximum and minimum values possible, if a continuous set, or a list of values, if a discrete set,
3. transformation—a formula used to convert the raw signals from a sensor associated with the resource into a normalized value corresponding to range and expressed as a list of operations in a Reverse Polish Notation (RPN) format. See, e.g., https://en.wikipedia.org/wiki/Reverse_Polish_notation, the entire disclosure of which is incorporated herein by reference.

Each conditional expression pair in a gate machine consists of a gate trigger conditional expression and a gate closure condition. A gate trigger conditional expression performs continual tests of the contents of one or more resources. The tests can be one of the following:
1. range membership—the contents of a resource are tested for membership in a continuous finite value range or continuous upper-or-lower bounded infinite value range,
2. discrete list membership—the contents of a resource are tested for membership in a discrete list of values.

When the gate trigger conditional expression is validated (e.g. reduces to true), a list of one or more associated processes are enabled, termed obligations. These obligations can be of the following type:
1. get resource—retrieve all the current contents of a resource including the latest reading of its associated sensor device which is translated via the transformation component of the resource,
2. net message—send a message to a resource in another gate machine and retrieve a response,
3. resource comparison—compare the contents of a resource with those of another resource in the same list or a constant value and, if the comparison is invalid (e.g. false), skip the next item in the list of obligations,
4. set resource—add or set a value to the contents of a resource from either the current contents of another resource or a constant value,
5. spectrum—compute a discrete interval spectrum from the contents of a resource.

After the gate trigger is validated, a list of obligations is executed continually. At the end of each obligation list execution cycle, the gate closure conditional expression is tested. If the expression is valid (e.g. reduces to true), the gate machine can proceed to test the gate triggers of one or more subsequent gates in its network. The operation of a gate is summarized in FIG. 1.

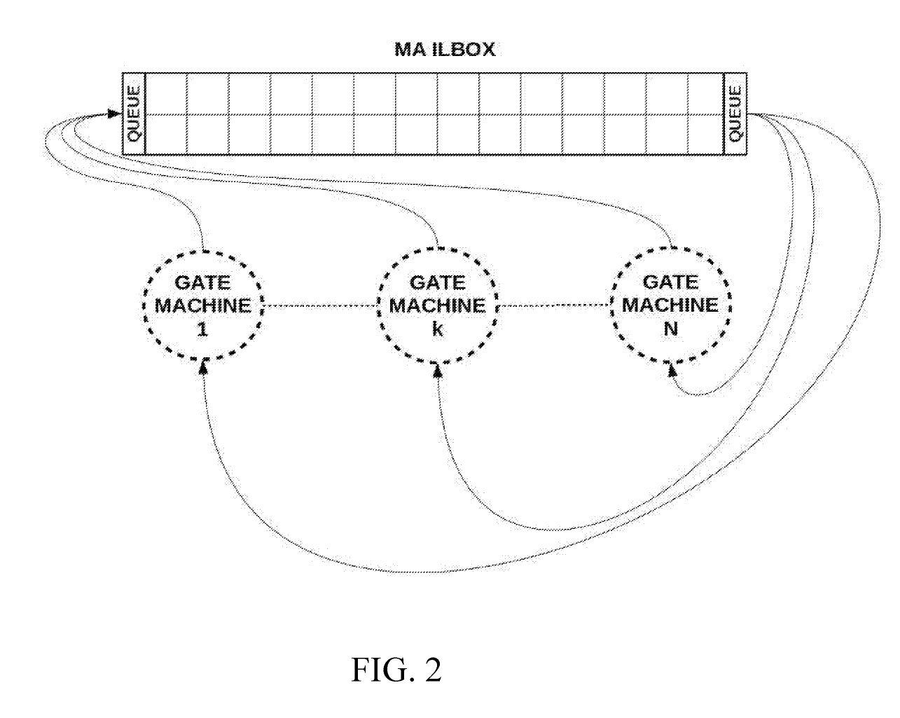

Whenever the net message obligation process is invoked, it enables a mechanism that synchronizes a gate machine with another. This mechanism is the inter-gate-machine mailbox server. It is a passive server that takes in gate machine messages, processes them based on their type, and returns a corresponding acknowledgement message. This process is performed only when requested, via message, by anyone of the gate machines in the network (hence its passivity), and is illustrated in FIG. 2.

The queues indicated in the mailbox manage message flow to and from the mailbox, with one queue focusing on receiving input messages and another on sending output acknowledgement messages.

Whenever the inter-gate-machine mailbox server is initialized, it retrieves information on identifiers used in addressing the gate machines in the network associated with the specific mailbox. This list of address labels may also include address labels of other mailbox servers. Once initialization is completed, the mailbox server proceeds with its message processing cycle.

The types of messages and processing of such messages is in accordance with the system of the present disclosure as follows:

A. Send the content of a specified mailbox to designated recipient(s)
1. input message: D, the corresponding gate machine address label,
   a list of 1 or more designated recipient(s).
2. processing: retrieve the contents of the mailbox associated with the gate machine and send per designated recipient(s) as follows:
   SELF—send the contents to the same gate machine that issued the messages,
   ALL—send the contents to all gate machines in the network,
   List of 1 or more specific gate machine address labels—
      send the contents to only these gate machines in the network,
3. output message: the contents of the mailbox associated with the gate machine to each designated recipient.

B. Broadcast the contents of a specified mailbox
1. input message: B, the address label of the source gate machine, a list of one or more gate machine address labels,
2. processing: retrieve the contents of the source gate machine's mailbox and send per designated recipient(s) as follows:
   ALL—send the contents to all gate machines in the network,
   List of specific gate machine address labels (1 or more)—
      send the contents to only these gate machines in the network,
3. output message: the contents of the mailbox associated with the gate machine to each designated recipient.

In this manner, a gate machine can change the contents of individual resources in another (target) gate machine; thus indirectly altering the behavior of the target gate machine by:
1. altering the results of the obligation processes in one or more gates,
2. preventing the triggering of a gate,
3. preventing the closure of a gate.

The network connecting gate machines to one another and to the mailbox server uses a peer-to-peer (e.g. Controller Area Network (“CAN”)) protocol. See, e.g., http://www.can-wiki.info/doku.php?id=start, the entire disclosure of which is incorporated herein by reference. Gate machines and gate machine networks can be applied directly to remedial control for unmanned platforms.

Remedial control is the application of changes to a pre-defined plan as a result of degradation in the behavior of internal components of the platform (e.g., payload, propulsion, communication). These changes are initiated by messages sent to the unmanned platform controller by gate machines “shadowing” internal components describing the behavior degradation. The controller then scans, interprets, and acts on these messages through it's own embedded gate machine that clears execution of mission tasks per the pre-defined mission plan.

The pre-defined mission plan is defined as a task list (see below). The assumptions in the task list conducts their tests by linking to specific, shared resources handle by one or more gate machines.

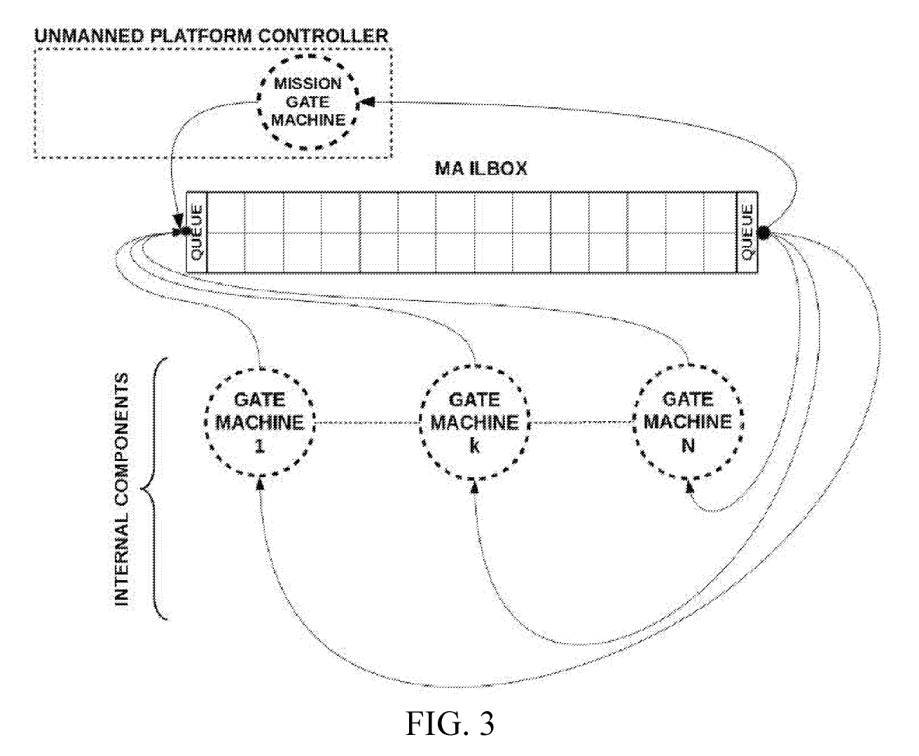

Inside the platform (e.g., flight) controller, a mission gate machine operates in conjunction with the gate machine network “shadowing” the internal components of the platform as described in FIG. 3. As outlined in FIG. 3, the mission gate machine interacts with the mailbox server just like the other gate machines “shadowing’ the internal components of the platform. The mission gate machine has a unique operation in that:
1. its gate trigger verifies a particular status of one or more internal components,
2. its obligations modify, if necessary, and enable execution of a mission task per the status
3. its gate closure verifies task completion or changes in the status of the internal components

Changes in the status in the internal components can lead to transition into another gate dealing with that change. Task completion, on the other hand, sets the corresponding assumption in the mission task list as valid (true) or invalid (false). This is done through resources in the mission gate machine shared with the task list.

As an example, take the following unmanned platform configuration and situation. A vertical take-off-and-landing (VTOL) unmanned platform consists of:
a flight controller managing a mission and embedded in the platform body
a gyro stabilizer assembly attached to the platform body
a camera attached to the gyro stabilizer assembly
an electric motor propulsion system
a battery power supply embedded in and supplying the platform

The mission of the platform is to provide continuous construction site survey over a 12 hour period. The gyro stabilizer assembly, propulsion system, and power supply have attached to each a gate machine “shadowing” their operation.

After being subject to multiple 12-hour operational cycles over a long time period, this configuration is subjected to 2 behavior degradation scenarios requiring remedial control:

Scenario #1—gyro stabilizer degradation: The gate “shadowing” servo response in the gyro stabilizer gate machine passes a resource comparison against the orientation change resource in its obligation list. This comparison senses an overshoot condition. So, the next item in the list is a net message that posts a gyro anomaly to the mission gate machine in the flight controller. As a result, the mission gate machine sets a gyro status resource to a restricted state. This resource is also part of an assumption test in the task list which, having failed, gives control to a task whereby the propulsion system manipulates the platform to compensate for the gyro stabilizer restriction in order to complete a stage of the current construction site survey. Following completion of that stage, the task places a gyro stabilizer replacement message in the log and returns the platform to base.

Scenario #2—unusual battery drainage rate: A gate trigger in the gate “shadowing” battery drainage in the power supply gate machine tests the drainage rate resource for being outside of an acceptable drainage rate. In this case, the trigger enables an obligation list that enables a net message posting a battery drainage anomaly to the mission gate machine. In a manner similar to the prior scenario, the assumption tests in the task list for the flight controller enable a task that slows the speed in order to reduce power use. Once that is completed, a resource is set with the current power level. This triggers an assumption test which enables a reduced-power task. This task calculates available power and determines flight time left at current power level. The flight time available is posted as a resource which triggers an assumption test for a limited survey task. This task, in turn, completes the next stage of the survey, places a battery replacement message in the maintenance log and returns the platform to base.

Extensions: The same network gate machine structure can be used to also operate the system itself. Thus, monitoring and control can be performed through a distributed hybrid (control+monitoring) system that exchanges, through a peer-to-peer protocol, commands that induce state changes. These changes, when carried out in a sequence of one-to-many cascade of commands, can also provide a modular approach to enable platform control mechanism by adding control functionality by simply attaching the associated system to the platform.

Another option is to integrate directly a task list (see below) to carry out mission tasks coupled with a gate machine network. In this configuration, assumptions in the task list are performed on resources shared directly with the gate machines, and not through a mission gate machine. Other applications areas for network gate machines are:
Robotics—integrate and coordinate the operation of a robot performing multiple operations and/or requiring the integration of multiple end effectors.
Security—provide an intelligent mechanism that can provide autonomous security in a building, warehouse, shop, or home requiring the integration and coordination of several devices needed to perform surveillance and notification actions.
Home Automation—integrate, coordinate, and monitor the operation of household appliances and devices, autonomously under minimal human supervision, to significantly streamline the day-to-day activities of home dwellers; in effect act as a robotic majordomo.
Building Facilities Management—integrate, coordinate, and monitor the operation of building infrastructure (e.g., HVAC, power distribution, plumbing), autonomously under minimal human supervision, in order to provide best possible comfort to residents and/or office workers following LEED guidelines. See, e.g., http://www.usgbc.org/articles/about-leed, the entire disclosure of which is incorporated herein by reference.
Traffic Management—coordinate, monitor, and integrate autonomously the operation of devices embedded in a roadway in order to enable self-driven vehicles and streamline traffic flow.

Assumption-Driven Task Interpreter: The Assumption Driven Task Interpreter verifies the condition of platform internals before executing a subset of platform controller commands. This verification provides the ability to skip one or more subsets of commands in case of degraded platform operation to a subsequent command subset that the platform is able to accomplish even under the detected degradation of the platform internals.

To begin with, a set commands can be partitioned into subsets of commands closely related to each other. These subsets are known as tasks. More specifically, a task can be viewed as an information structure consisting of the following components:
1. TaskID—a label (pointer) identifying this task.
2. TaskBody—the list of commands within a subset encapsulated in this task.
3. Assumptions—a list of tests against the current settings of a set of parameters gaging the condition of platform internals (settings are supplied through a NGM network, see Networked Gate Machines disclosure). It is implemented as conjunction of condition test that either result in a value of true or false.
4. NextTask—TaskID for the next task to follow if the tests in Assumptions show no degradation (or fault) in platform internals.
5. SkipToTask—TaskID for the next task to follow if the tests in Assumptions show degraded (or faulty) behavior in platform internals.

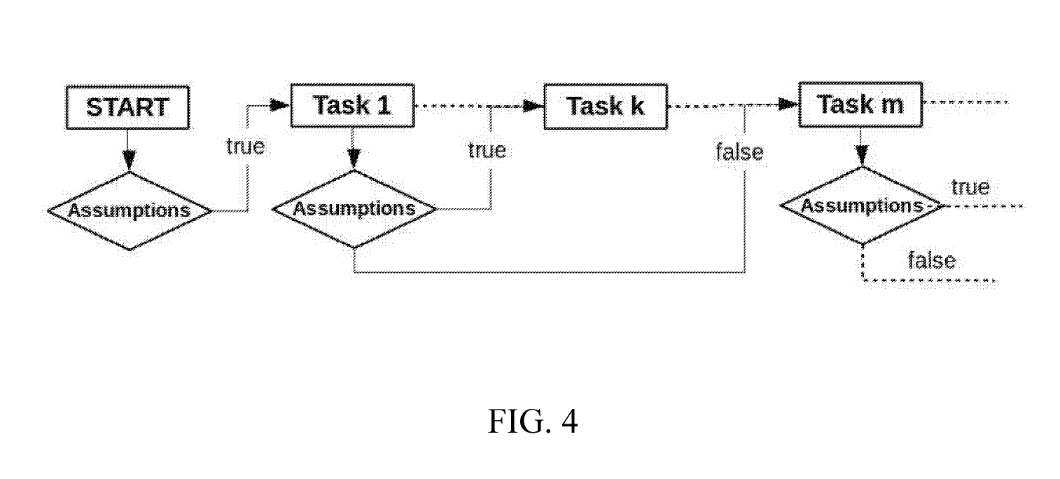

Thus, the original set of commands is transformed into a list of tasks. The operation of this task list is summarized in FIG. 4.

In effect, operation of the list is a traversal through a dynamic network. The traversal is driven by the results of the Assumptions tests whose results can vary over time depending on the settings of the platform internals gaging parameters.

START is a special task simply used to commence the network traversal. Its components are as follows:
1. TaskID—START
2. TaskBody—NONE
3. Assumptions—NONE
4. NextTask—Task 1
5. SkipToTask—NONE

In effect, START just enables passage to Task 1. Any task ending the list will have NextTask pointing to START to restart the network traversal.

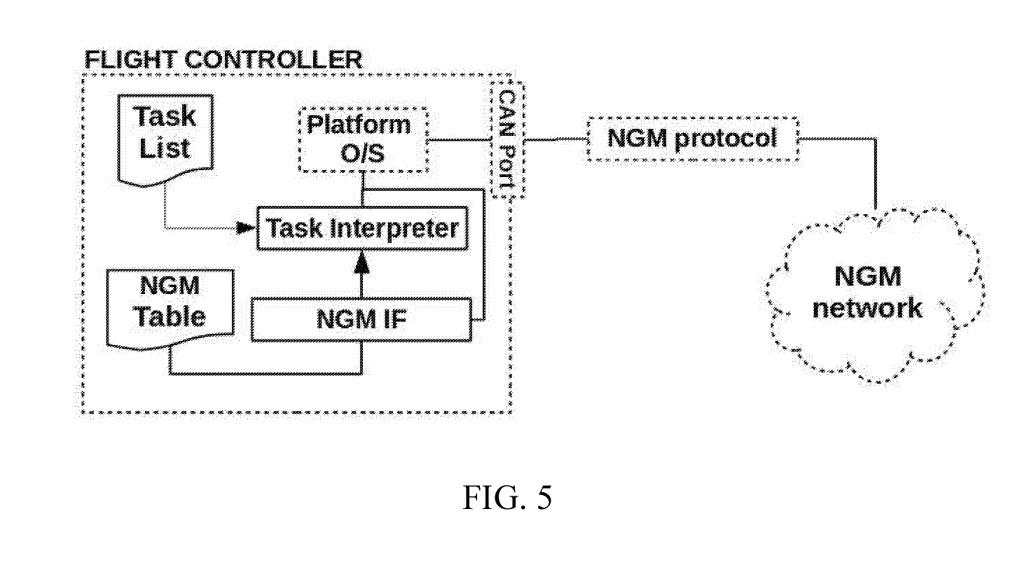

This structure is followed because of the algorithm involved in network traversal which is implemented through the configuration outlined in FIG. 5. The components in FIG. 5 are as follows:
A. Next Generation Mobile (“NGM”) network—(see above)
B. NGM protocol—(see above)
C. CAN Port—hardware attachment point to the NGM network supporting the CAN (Controller Area Network) protocol.
D. Platform O/S—operating system managing hardware resources and software operation in the flight controller (e.g. ROS, Linux)
E. Task List—an internal representation of the task list described above
F. NGM Table—an internal list of the latest settings for the platform internals gaging parameters.
G. NGM IF—an internal process retrieving settings for the platform internals gaging parameters and also supplying them to the Task Interpreter.
H. Task Interpreter—an internal process enabling network traversal of the Task List.

The key elements in this configuration are the last 2. First, NGM IF consists of 2 components. The first one, NGM Store, is an interrupt handler under the Platform O/S associated with CAN Port events and operates as follows:
1. Retrieve any NGM protocol messages received through the CAN Port.
2. Extract platform internals gaging parameters from the messages.
3. Store extracted setting in the appropriate slots of the NGM Table.

The second component, NGM Get, is a function used by the Task Interpreter that, given a platform internals gaging parameter label (pointer), retrieves the latest stored setting associated with that parameter.

The Task Interpreter is basically a daemon (process that is always enabled and runs in a priority just below the Platform O/S) and operates as follows:

A. Loop Always
1. Set ThisTask to START.
2. Set ThisAssumption to true.
3. For ThisTask in Task List,
   1. Retrieve the components of ThisTask (TaskBody, Assumptions, NextTask, SkipToTask).
   2. Perform the command list in TaskBody for ThisTask.
   3. Retrieve the current setting for the gaging parameters used in Assumptions for ThisTask.
   4. Perform the tests and their conjunction in Assumptions for ThisTask
      If the results in (4) above yield true (i.e., no degradations detected) then set ThisTask to NextTask; else set ThisTask to SkipToTask.

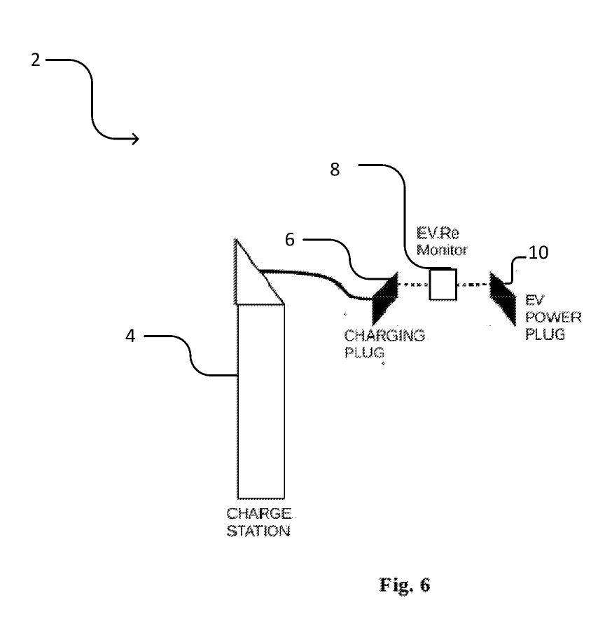

FIG. 6 is a diagram of an electric charging system 2 in accordance with the present disclosure. The charging station 2 includes a charge station 4, a charging plug 6, a monitor 8, and an electric vehicle (“EV”) power plug 10. The charge station 4 provides electrical power for charging an electric vehicle. The charging plug 6 can be connected to the charge station 4 and the monitor 8 so that the system of the present disclosure can monitor a number of variables as will be explained in greater detail below. The charging plug 6 is in electrical communication with the charge station 4 so that electric power can be transmitted. The charging plug 6 can be connected to an EV power plug 10 so that electrical power can be transferred from the charge station 4 to an electric vehicle connected to the EV power plug 10. The monitor 8 can also be connected to the EV power plug 10 so that a number of variables can be monitored as will be explained in greater detail below. The monitor 8 can be a software process executed by a processor in the charging plug 6 for performing the functions as described herein. The monitor 8 can alternatively be a physical device having its own processor for executing the functions as described herein.

The electric charging system 2 of the present disclosure can include a plurality of networked gate machines such as the network gate machines discussed above in connection with FIGS. 1-5. The network gate machines can be encapsulated in the monitor 8 or any other portion of the electric charging station 2. The network gate machines can also be included in a remote or a local server connected to the Internet. The electric charging station 2 can be coupled to an allocation system at a distribution hub which can balance and manage a power allocation schedule among a plurality of electric vehicles with no disruption to other regional power needs.

The network gate machines of the electric charging station 2 can include a plurality of parameters. For example, an EvChargeLvl parameter is a percentage of charge available to EV batteries or a power source. An EVCapacity parameter is the total EV charge capacity which can be expressed in ampere-hours. An RequestLvl parameter can be an ampere-hours (or some other current measure) requested by the distribution hub based on the EVChargeLvl parameter. An AllocLvl parameter can be an ampere-hours (or some other current measure) allocated by the distribution hub based on the RequestLvl parameter. A PwrPlugIn parameter is a true/false indicator of whether a plug from the charging station is attached to an electric vehicle.

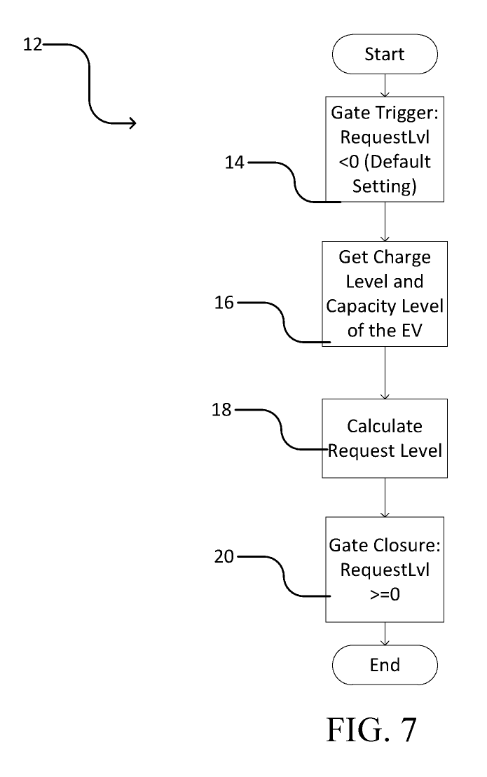

FIG. 7 is a flowchart illustrating processing steps 12 for configuring a network gate machine of the present disclosure. In step 14, a decision is made as to whether the RequestLvl parameter is less than 0. The RequestLvl parameter is set to 0 by default. If a positive determination is made in step 14, the gate can be triggered and the process proceeds to step 16 and if a negative determination is made, the process ends. In step 16, the system can retrieve the electric vehicle's charge level and capacity for power storage (the EvChargeLvl and EVCapacity parameters). In step 18, the system can calculate the how much power to request from the distribution hub (the RequestLvl parameter) based on the electric vehicles charge level and charge capacity. In step 20, the system can set the gate to close by setting the RequestLvl parameter to the calculated amount in step 18.

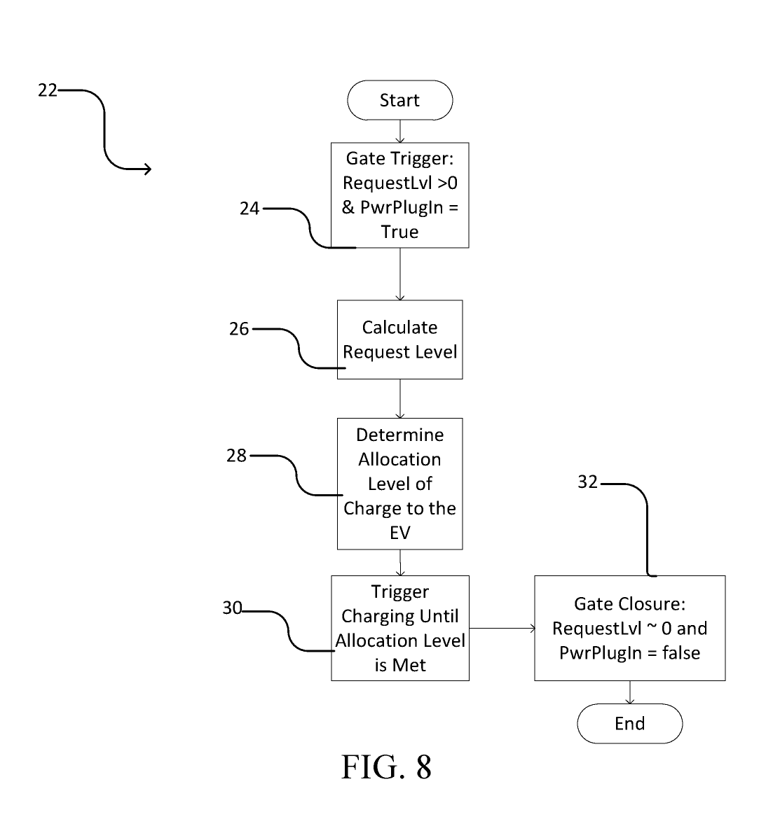

FIG. 8 is a flowchart illustrating processing steps 22 for charging an electric vehicle. In step 24, the system can make a determination as to whether the RequestLvl is greater than 0 and whether PwrPlugIn parameter is true. In other words, the system can trigger the gate (and begin the process 22) when an electric vehicle is requesting a charge (e.g., when the RequestLvl parameter is greater than 0) and when an electric vehicle is plugged into the electric charging station 2. If the determination in step 24 is positive, the process proceeds to step 26 and if the determination is negative, the process ends. In step 26, the system can calculate the how much power to request from the distribution hub (the RequestLvl parameter) based on the electric vehicles charge level and charge capacity. In step 28, the system can communicate the RequestLvl parameter to the distribution hub and negotiate the RequestLvl parameter with the distribution hub. The system will receive the allocation amount of charge to be given to the electric vehicle and can accordingly set the AllocLvl parameter to such an amount. In step 30, the system can begin charging the electric vehicle up to the amount of charge allocated by and negotiated with the distribution hub (the AllocLvl parameter). In step 32, the system can close the gate and the process 22 when the RequestLvl parameter is near or close to 0 and the electric vehicle is no longer plugged into the electric charging station 2 (the PwrPlugIn variable is false). As the vehicle is charging, the RequestLvl parameter goes lower toward zero because the eclectic vehicle needs lesser of a charge.

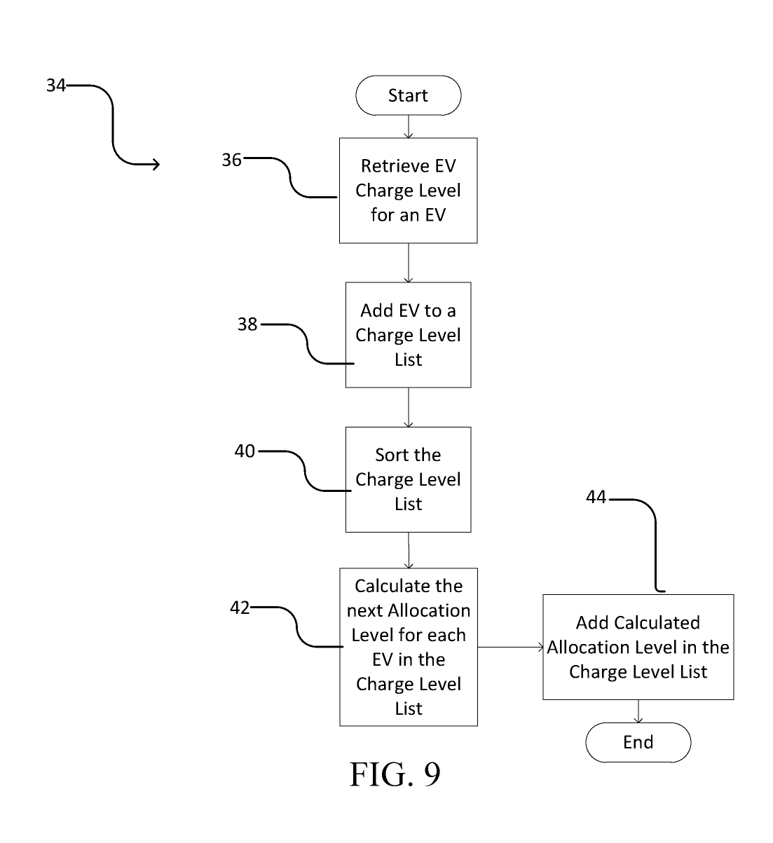

FIG. 9 is a flowchart illustrating processing steps 34 for implementing an inter-gate machine mailbox server. The inter-gate machine can manage delivery of allocation requests and responses to and from individual gate machines attached to each electric charge station 4 in a network of a plurality of electric charge stations. A mission gate machine generating allocations (AllocLvl parameter) to electric charge stations can be handled through a dynamic, priority-driven, round-robin scheduler, where setting a priority value is directly proportional to a charge station's request level (RequestLvl). A higher priority can get a larger allocation in the system of the present disclosure. In step 36, when the network gate machine for charging finishes charging an electric vehicle, the system or inter-gate machine can retrieve the electric vehicle's charge level (EVChargeLvl). In step 38, the system can add the electric vehicle from step 36 to a charge level list (“CLL”) along with an electric vehicle ID of the electric vehicle. The CLL includes a list of a plurality of electric vehicles in the system. In step 40, the system can sort the CLL in ascending order by the electric charge level (EVChargeLvl) of the plurality of electric vehicles in the CLL. In step 42, the system can, for each electric vehicle entry in the CLL, calculate the next allocation level (AllocLvl) to be given to an electric vehicle. The calculation can be done using the following formula: TtlEvBandwidth*(1−(EVChargeLvl/TtlLvls)), where TtlEvBandwidth is the total charge bandwidth available for all electric vehicles at the distribution hub, TtlLvls is the sum of all the electric vehicles' charge levels in the CLL. In step 44, the system can add the calculated allocation level (AllocLvl) from step 42 as an entry in the CLL corresponding to the electric vehicle the allocation level was calculated for. The inter-gate machine can use the recalculated AllocLvl in the CLL on the next cycle for charging the electric vehicle. The charging station can begin charging an electric vehicle upon receiving the calculated allocation level and can stop charging once the vehicle's charge level has reached the allocation level.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

What is claimed is:

1. A method for managing a plurality of charging stations for charging a plurality of electric vehicles comprising:
receiving a plurality of charge levels for each of the plurality of electric vehicles, the plurality of charge levels each indicating an amount of charge remaining in a battery installed in each of the plurality of electric vehicles;
calculating an allocation level for each of the plurality of electric vehicles based on each electric vehicle's charge level, a total amount of charging bandwidth available for the plurality of charging stations, and a sum of all the plurality of charge levels for the plurality of electric vehicles;
receiving a request from at least one of the plurality of charging stations for charging at least one of the plurality of electric vehicles for a requested charge level; and
transmitting, to the at least one of the plurality of charging stations, the at least one of the plurality of electric vehicle's calculated allocation level.

2. The method of claim 1, further comprising the step of creating a list of the plurality of charge levels for each of the plurality of electric vehicles and sorting the list in ascending order.

3. The method of claim 2, further comprising the step of assigning a priority value to each of the plurality of electric vehicles based on an order of the plurality of electric vehicles in the list.

4. The method of claim 1, further comprising the step of calculating the requested charge level based on the at least one of the plurality of electric vehicles battery capacity and charge level.

5. A system for charging a plurality of electric vehicles comprising:
a plurality of electrical charging stations each having a charge station for providing electrical charging capacity to the plurality of electric vehicles, and a memory and processor for receiving and transmitting information; and
a computing device located at a power utility and having a memory and processor, the computing device in communication with the plurality of charging stations and having computer instructions for:
receiving a plurality of charge levels for each of the plurality of electric vehicles, the plurality of charge levels each indicating an amount of charge remaining in a battery installed in each of the plurality of electric vehicles;
calculating an allocation level for each of the plurality of electric vehicles based on each electric vehicle's charge level, a total amount of charging bandwidth available for the plurality of charging stations, and a sum of all the plurality of charge levels for the plurality of electric vehicles;
receiving a request from at least one of the plurality of electrical charging stations for charging at least one of the plurality of electric vehicles for a requested charge level; and
transmitting, to the at least one of the plurality of electrical charging stations, the at least one of the plurality of electric vehicle's calculated allocation level.

6. The system of claim 5, wherein each of the plurality of electrical charging stations further comprises a charging plug and an electrical vehicle power plug for providing electrical power to an electrical vehicle.

7. The system of claim 5, wherein the requested charge level is calculated by the at least one of the plurality of electrical charging station.

8. The system of claim 7, wherein the requested charge level is calculated based on the at least one of the plurality of electric vehicles battery capacity and charge level.

9. The system of claim 5, wherein the central server creates a list of the plurality of charge levels for each of the plurality of electric vehicles and sorts the list in ascending order.

10. The system of claim 9, wherein the central server assigns a priority value to each of the plurality of electric vehicles based on an order of the plurality of electric vehicles in the list.

11. The system of claim 5, wherein the at least one of the plurality of electrical charging stations calculates the requested charge level based on the at least one of the plurality of electric vehicles battery capacity and charge level.

12. The system of claim 5, wherein the at least one of the plurality of charging stations begins charging the at least one of the plurality of electric vehicles upon receiving the at least one of the plurality of electric vehicle's calculated allocation level from the central server.

13. The system of claim 12, wherein the at least one of the plurality of charging stations stops charging the at least one of the plurality of electric vehicles once the at least one of the plurality of electric vehicle's calculated allocation level is met.

14. A method for managing at least one charging station for charging a plurality of electric vehicles comprising:
receiving a plurality of charge levels for each of the plurality of electric vehicles, the plurality of charge levels each indicating an amount of charge remaining in a battery installed in each of the plurality of electric vehicles;
calculating an allocation level for each of the plurality of electric vehicles based on each electric vehicle's charge level, a total amount of charging bandwidth available for the at least one charging station, and a sum of all the plurality of charge levels for the plurality of electric vehicles;
receiving a request from the at least one charging station for charging at least one of the plurality of electric vehicles for a requested charge level; and
transmitting, to the at least one charging station, the at least one of the plurality of electric vehicle's calculated allocation level.

15. The method of claim 14, further comprising the step of creating a list of the plurality of charge levels for each of the plurality of electric vehicles and sorting the list in ascending order.

16. The method of claim 15, further comprising the step of assigning a priority value to each of the plurality of electric vehicles based on an order of the plurality of electric vehicles in the list.

17. The method of claim 16, further comprising the step of calculating the requested charge level based on the at least one of the plurality of electric vehicles battery capacity and charge level.
